(19) United States
(12) Patent Application Publication
(10) Pub. No.: US 2017/0314576 A1
(43) Pub. Date: Nov. 2, 2017

(54) METHOD FOR CREATING AN IMPELLER OF A RADIAL TURBO FLUID ENERGY MACHINE, AND STAGE

(71) Applicant: Siemens Aktiengesellschaft, Munich (DE)

(72) Inventor: Werner Jonen, Duisburg (DE)

(73) Assignee: Siemens Aktiengesellschaft, Munich (DE)

(21) Appl. No.: 15/523,143

(22) PCT Filed: Oct. 21, 2015
(86) PCT No.: PCT/EP2015/074293

§ 371 Date: Apr. 28, 2017

(30) Foreign Application Priority Data
Nov. 10, 2014 (DE) 10 2014 222 877.8

(51) Int. Cl. F04D 29/68; F01D 5/04; F04D 29/30; F04D 29/44; F04D 29/28

(52) U.S. Cl. CPC F04D 29/681; F04D 29/441; F04D 29/284; F04D 29/30; F01D 5/048; F05D 2230/50; F05D 2240/31; F05D 2300/516

(57) ABSTRACT

A method for creating an impeller and an impeller of a radial turbo fluid energy machine includes a wheel disc, cover disc, blades, and hub. The hub is mounted on a shaft which extends along an axis, the wheel disc extends substantially radially from the hub, and the cover disc is connected to the wheel disc by the blades such that flow channels separated from one another in the circumferential direction are defined by the blades. The impeller has a first flow passage in a substantially axial direction in the radial proximity of the hub, and the impeller has a second flow passage in a substantially radial direction radially farther away from the hub than the first flow path passage. The cover disc surface facing the wheel disc has a lower degree of roughness at least in some regions than the wheel disc surface facing the cover disc.

### CROSS REFERENCE TO RELATED APPLICATIONS

This application is the US National Stage of International Application No. PCT/EP2015/074293 filed Oct. 21, 2015, and claims the benefit thereof. The International Application claims the benefit of German Application No. DE 102014222877.8 filed Nov. 10, 2014. All of the applications are incorporated by reference herein in their entirety.

### FIELD OF INVENTION

The invention relates to a method for creating an impeller of a radial turbo fluid energy machine, and to an impeller comprising: a wheel disk, a cover disk, blades and a hub. In this case, the hub is designed to be mounted on a shaft which extends along an axis, wherein the wheel disk extends essentially radially from the hub, wherein the cover disk is connected to the wheel disk by means of the blades such that flow channels which are separated from one another in the circumferential direction are defined by the blades between the wheel disk and the cover disk in the circumferential direction in at least one radial region of the impeller, wherein the impeller has a first flow path passage in an essentially axial direction in the radial proximity of the hub, wherein the impeller has a second flow path passage radially farther away in an essentially radial direction from the hub than the first flow path passage. The invention also deals with a stage comprising an impeller so defined.

### BACKGROUND OF INVENTION

Turbo fluid energy machines of that kind are known as compressors or expanders. In this context, the radial construction of an impeller can be open or closed, and the invention deals with the closed impeller, meaning that a cover disk opposite the wheel disk defines the individual flow channels axially and radially. When flow passes through and around radial impellers, the surfaces wetted by the flow experience friction-induced pressure losses which reduce the efficiency of the turbomachine. For a given set of operating conditions in terms of the type of gas, the pressure and the temperature, the local friction-induced pressure losses are dependent on the local flow velocity and the local roughness of the surfaces wetted by the flow.

It is already known, from EP 0 593 797 B 1, to set the roughness of components in a targeted manner, to change flow effects caused thereby, and to apply this knowledge to a radial turbocompressor.

### SUMMARY OF INVENTION

Proceeding from the described drawbacks of the prior art, the invention has set itself the object of improving the efficiency of radial turbo fluid energy machines of the type mentioned in the introduction without increasing the hitherto necessary production complexity. To achieve the object according to the invention, there is proposed a method of creating an impeller of the type mentioned in the introduction, having the features of the independent claim. Also proposed is a stage according to the claims. The subclaims which respectively refer back contain advantageous refinements of the invention.

The terminology of the invention assumes that, during production, a uniform roughness is at first provided on the corresponding components (cover disk, wheel disk, blades and hub) of the impeller according to the invention, and this roughness is reduced by an additional treatment in the respective regions defined according to the invention. This always results in surface regions having a lower degree of roughness and other regions in which this treatment has not been carried out and which have a higher degree of roughness in comparison thereto. It is in principle also conceivable, according to the invention, to increase the degree of roughness of the remaining regions in comparison to those regions in which the degree of roughness is reduced. However, this variant is less advantageous.

Large pressure losses arise where the local flow velocities and the local roughnesses of the surfaces in contact with the flow are high. Usually, for the flow-wetted surfaces of the impellers mentioned in the introduction, which are also termed radial wheels, both in the blade channel—that is to say with respect to the blade surfaces or the impeller channel bases in the interior of the impeller—and also externally on the wheel disk or on the cover disk, an in each case uniform maximum permissible roughness is required. This roughness is for example indicated with the standardized indication RZ12. This uniform roughness is required in particular when the relevant surfaces are created from one component or blank, or undergo a common final production step.

Turbomachines which in part have generic features are already known from documents US 2007/0 134 086 A1, U.S. Pat. No. 2,471,174 A1, EP 0 593 797 B1 and WO 2013/162 896 A1.

The current practice of providing the impeller and corresponding components of the turbo fluid energy machine, which are wetted by the flow, with a uniform surface quality leads to high production complexity and high costs when attempting to minimize flow losses caused thereby. Corresponding polishing and measures for reducing surface roughness must frequently be carried out by hand and are therefore very cost-intensive. The invention avoids part of these costs.

In the above generic definition of the impeller, the hub is introduced as an at least separate term. In general, the hub is formed in one piece with the wheel disk and is accordingly separated only conceptually owing to the function of connecting to the shaft. In this context, it is conceivable for the hub, the wheel disk and the blades to be formed in one piece or even produced from a single blank. Moreover, it is also conceivable for the cover disk, the blades, the wheel disk and the hub to be formed in one piece or even produced from a single blank, for example by means of modern milling methods or by eroding. In the context of the most recent developments, production by “additive manufacturing” is also conceivable.

One insight according to the invention is that, conventionally, the local flow velocity is often not expediently adapted to a given local surface roughness. This results in high friction-induced pressure losses in those regions where high local flow velocities coincide with high degrees of roughness. The invention therefore proposes to embody the flow-wetted surface with a lower degree of roughness in the region of high flow velocities than in the region of lower flow velocities.

In addition, the invention also proposes a method for creating a rotating component, wetted by a flow, of a fluid energy machine, having the steps of: a. fluidic design of the component, b. fixing at least one limit value for a first quotient from the surface flow velocity over surface regions of the component at a distance δ divided by a circumferential velocity in each case related to a design operating point, c. determining surface regions of the component, in which the first quotient is above the limit value, d. creating the component, with the creation of at least two different degrees of roughness for surface regions, a first, lower roughness in at least some surface regions in which the first quotient is above the limit value, and the creation or retention of a higher degree of roughness in at least some surface regions, in which the first quotient is below the limit value.

The invention also deals with a component created according to the above-defined method. Particular advantage is given here to the impeller of a radial turbo fluid energy machine, in particular a radial turbocompressor.

One advantageous refinement of the invention provides that the component is created from a one-piece blank. Another advantageous refinement of the invention provides that the component is of one-piece design, wherein advantageously no non-destructively separable parts are provided on the component. Another advantageous refinement of the invention provides that, in one production step, surface regions belonging to a first group of surface regions undergo treatment to reduce the surface roughness. Another advantageous refinement of the invention provides that, in a further production step, surface regions assigned to a second group of surface regions undergo treatment to increase the surface roughness.

### BRIEF DESCRIPTION OF THE DRAWINGS

The invention is described in greater detail below with reference to a specific exemplary embodiment, with reference to drawings. In the drawings:

FIG. 1 is a view in longitudinal section along an axis of a rotor of a radial turbo fluid energy machine, through an impeller according to the invention,

FIG. 2 is a detail view along II in FIG. 1,

FIG. 3 is a flow chart for a method according to the invention.

### DETAILED DESCRIPTION OF INVENTION

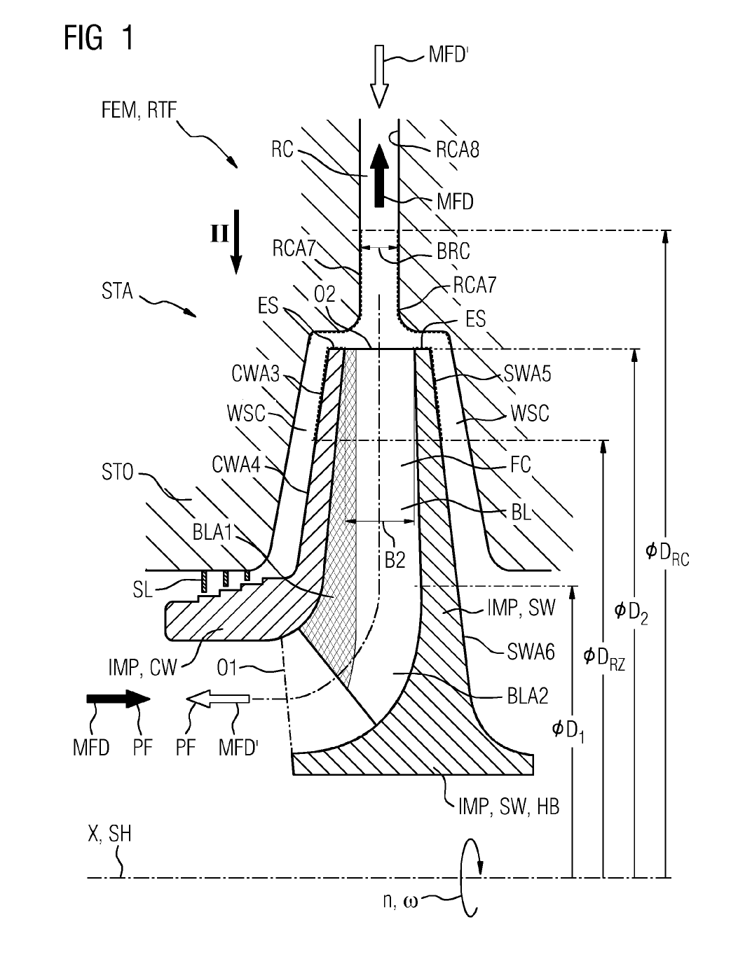

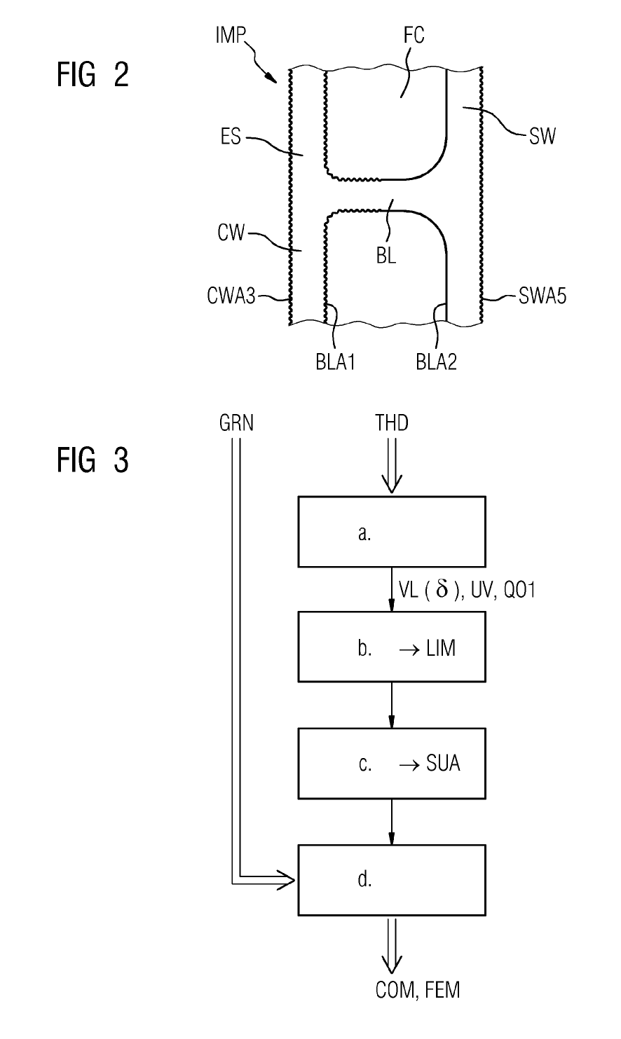

FIG. 1 shows an impeller IMP of a radial turbo fluid energy machine RTF, which is schematically represented here by way of a detail with one stage STA. A process fluid PF flows along a main flow direction MFD through the impeller IMP when the latter is operating as a compressor. If the impeller IMP is used in a radial turbo fluid energy machine designed as a turbine, the process fluid PF flows along a main flow direction MFD′ that is oriented counter to the main flow direction MFD for the compressor. If, in the following, reference is made to a specific main flow direction MFD, MFD′, this is done with reference to a design of the radial turbo fluid energy machine RTF as a compressor, without restricting the invention to a compressor.

The impeller IMP comprises a wheel disk SW, blades BL and a cover disk CW, wherein the wheel disk SW comprises a hub HB. By means of the hub HB, the impeller IMP is mounted on a shaft SH (not shown) which extends along a rotation axis X. Unless otherwise stated, in the following all of the terms relating to an axis, for example axial, radial, circumferential direction etc., relate to this rotation axis X.

In the example shown, the blade BL is of three-dimensional twisted design over the breadth direction of the flow channel FC. This design is typical for impellers having a high maximum flow rate. The blades BL extend not only in the essentially radial section of the flow channel FC but also in the axial section.

Application of the invention to impellers IMP with blades BL located essentially in the radial section is also expedient. These impellers IMP are more frequently used in what are termed high-pressure compressors and generally have essentially cylindrical blades BL.

The wheel disk SW extends essentially radially from the hub HB. The cover disk CW is connected to the wheel disk SW by the blades BL. This produces, between the wheel disk SW and the cover disk CW, flow channels FC that are separated from one another in the circumferential direction in at least one radial region of the impeller IMP by the blades BL. In those radial regions into which the blade BL does not extend, there is no circumferential separation of the flow channel FC, and furthermore a common flow channel is defined radially and axially by the wheel disk SW and the cover disk CW.

The main flow direction MFD extends essentially midway between the wheel disk SW and the cover disk CW, from an axial direction in the region of the inflow in the case of the compressor, along a redirection into the radial direction to an outlet from the impeller IMP. For the sake of universality of terminology of the invention, that section of the impeller IMP which is referred to as the inlet in the case of the radial turbocompressor is labeled the first flow path passage O1. Similarly, the outlet is labeled the second flow path passage O2.

The impeller IMP is surrounded by a stator STO which, with a distance between the impeller IMP and the stator STO, defines what are referred to as wheel side chambers WSC on either side of the impeller IMP.

It is shown by way of example, to the left of the impeller IMP, how the wheel side chamber WSC is sealed by means of a shaft seal in the form of a labyrinth seal in order to avoid undesired bypass flow through the wheel side chamber WSC past the flow channel FC of the impeller IMP. In practice, a similar seal is also to be found to the right of the impeller IMP, but is not shown here. The flow channel FC of the impeller IMP opens in the radial direction into a ring chamber RC of the stator STO, such that in the case of a compressor the process fluid FD can continue to follow the outflow direction MFD and can leave the impeller IMP, and can possibly be guided into a final recirculation stage (not shown) to another impeller IMP or into a collection space to flow out of the radial turbo fluid energy machine RTF.

The cover disk CW surface facing the wheel disk SW is formed with a lower degree of roughness at least in some regions—and in the example in its entirety—than the wheel disk SW surface facing the cover disk. In this context, it is provided that the blades BL have a lower degree of roughness in a first blade surface region BLA1 closer and adjacent to the cover disk CW than a second blade surface region BLA2, of the blades, farther away from the cover disk CW. It is also provided that, with increasing distance from the hub HB, the first blade surface region BLA1 has a decreasing proportion of the flow channel FC perpendicular to the main flow direction MFD. Specifically, in the illustrated case of a blade BL of three-dimensionally twisted design over the breadth direction of the flow channel FC, the first blade surface region BLA1 extends over more than 40% of the breadth of the flow channel FC perpendicular to the main flow direction MFD in that section closest to the hub HB, and reduces continuously until that section radially farthest away from the hub HB, to less than 35% of the breadth of the flow channel FC perpendicular to the main flow direction MFD.

Next to the interior of the impeller IMP, part of the outer surface of the impeller IMP is also adapted in terms of roughness for the purpose of loss reduction. In a third surface region CWA3, the cover disk CW is designed, on the surface oriented away from the blades BL, with a lower degree of roughness than in another, fourth surface region CWA4. The third surface region CWA3 extends radially over a radially outer portion of up to 50% of the radial extent of the cover disk CW. In the drawing, the smallest diameter with reduced roughness is indicated with DRZ, wherein the region extends to the outermost diameter D2 of the impeller IMP. In the specific exemplary embodiment, the smallest diameter with reduced roughness DRZ is identical for the cover disk CW and for the wheel disk SW. In practice, the respective diameters for the cover disk and for the wheel disk can be different. In a fifth surface region SWA5, the wheel disk has, on the surface oriented away from the blades BL, a lower degree of roughness than in another, sixth surface region SWA6. Expediently, the fifth surface region SWA5 extends radially over an outer portion of up to 50% of the radial extent of the wheel disk.

A radially outer, circumferentially extending annular edge surface ES both of the cover disk CW and of the wheel disk SW is embodied in each case with a lower degree of roughness than the other regions, which do not have a lower degree of roughness. Advantageously and expediently, this lower degree of roughness is also used for the outermost edges of the blades BL.

FIG. 3 shows, schematically, a flow chart of a method according to the invention for creating a flow-wetted component COM of a fluid energy machine FEM. This can for example be an impeller IMP or part of a stage STA that is wetted by a flow.

The method is intended to create the wetted component COM from a blank GRN, on the basis of thermodynamic data THD.

A first step a. involves the fluidic design of the component COM using the thermodynamic data THD. The first design step forms the basis for the second step b. in which a limit value LIM is fixed for a first quotient QO1 from the surface flow velocity VL over surface regions SUA of the component COM at a distance δ divided by a circumferential velocity UV in each case related to a design operating point. This surface flow velocity VL can be found from the appropriate fluid dynamics calculations at a certain distance δ from the actual component surface. The circumferential velocity can be found from the design operating point, directly from the respective diameter and rotational speed (n, ω). While, in the example of FIG. 3, only one limit value LIM for the first quotient QO1 is established, it is also possible, in the context of the invention, to establish quotient value ranges defined by lower and upper limit values to which, in subsequent steps, are assigned surface regions SUA in which, in the context of production, various degrees of roughness are to be provided.

A third step c. involves using the limit value LIM to determine a surface region SUA which is above the limit value LIM in terms of the first quotient QO1. Accordingly, in the exemplary embodiment of FIG. 3, the surface of the component COM is divided into two groups: one group for which the first quotient QO1 is above the limit value LIM, and one group for which the first quotient QO1 is below the limit value LIM.

A fourth step d. concerns creating the component COM from a blank and creating at least two different degrees of roughness RZ for the surface regions SUA. The blank GRN can be in the form of a raw workpiece for milling from solid, of a semi-finished product, in pieces or even in the form of a powder for sintering, or in the form of any other raw material for creating the component COM. What is essential to the meaning of the invention is that a surface quality is created in one processing step according to the invention.

A first, lower degree of roughness RZ is created in at least some surface regions SUA in which the surface flow velocity VL is above the limit value LIM. A higher degree of roughness RZ is created or left in at least some surface regions SUA, in which the surface flow velocity VL is below the limit value LIM.

The method according to the invention produces the component COM of a fluid energy machine FEM.

1.-11. (canceled)

12. A method for creating an impeller of a radial turbo fluid energy machine, the method comprising:
a. fluidic designing of the component,
b. fixing at least one limit value for a first quotient from the surface flow velocity over surface regions of the component at a distance divided by a circumferential velocity in each case related to a design operating point,
c. determining surface regions of the component, in which the first quotient is above the limit value,
d. creating the component, with the creation of at least two different degrees of roughness for surface regions, a first, lower roughness in at least some surface regions in which the first quotient is above the limit value, and the creation or retention of a higher degree of roughness in at least some surface regions, in which the first quotient is below the limit value.

13. An impeller of a radial turbo fluid energy machine created according to a method as claimed in claim 12, comprising
a wheel disk,
a cover disk,
blades,
a hub,
wherein the hub is designed to be mounted on a shaft which extends along an axis,
wherein the wheel disk extends essentially radially from the hub,
wherein the cover disk is connected to the wheel disk by means of the blades such that flow channels which are separated from one another in the circumferential direction are defined by the blades between the wheel disk and the cover disk in the circumferential direction in at least one radial region of the impeller,
wherein the impeller has a first flow path passage in an essentially axial direction in the radial proximity of the hub,
wherein the impeller has a second flow path passage radially farther away in an essentially radial direction from the hub than the first flow path passage,
wherein the cover disk surface facing the wheel disk has a lower degree of roughness at least in some regions than the wheel disk surface facing the cover disk.

14. The impeller as claimed in claim 13,
wherein the blades have a lower degree of roughness in a first blade surface region closer and adjacent to the cover disk than a second blade surface region, of the blades, farther away from the cover disk.

15. The impeller as claimed in claim 14,
wherein, with increasing distance from the hub, the first blade surface region has a decreasing proportion of the flow channel perpendicular to the main flow direction.

16. The impeller as claimed in claim 15,
wherein the blade is designed as a three-dimensionally twisted blade,
wherein the first blade surface region extends over more than 40% of the breadth of the flow channel perpendicular to the main flow direction in that section closest to the hub, and reduces continuously until that section farthest away from the hub, to less than 35% of the breadth of the flow channel perpendicular to the main flow direction.

17. The impeller as claimed in claim 15,
wherein the blade is designed as an essentially cylindrical blade,
wherein the first blade surface region extends over more than 40% of the breadth of the flow channel perpendicular to the main flow direction in that section closest to the hub, and increases continuously until that section farthest away from the hub, to more than 70% of the breadth of the flow channel perpendicular to the main flow direction.

18. The impeller as claimed in claim 13,
wherein, in a third surface region, the cover disk has, on the surface oriented away from the blades, a lower degree of roughness than in another, fourth surface region,
wherein the third surface region extends radially over an outer portion of up to 50% of the radial extent of the cover disk.

19. The impeller as claimed in claim 18,
wherein, in a fifth surface region, the wheel disk has, on the surface oriented away from the blades, a lower degree of roughness than in another, sixth surface region,
wherein the fifth surface region extends radially over an outer portion of 10% to 50% of the radial extent of the wheel disk.

20. The impeller as claimed in claim 13,
wherein the cover disk and/or the wheel disk each have a radially outer edge surface which extends in the circumferential direction and has a lower degree of roughness than the other regions which do not have a lower degree of roughness.

21. A stage of a radial turbo fluid energy machine, comprising
a rotating impeller as claimed in claim 19, and
a stator surrounding the impeller,
wherein the stator has, adjoining the second flow path passage, a ring chamber which extends essentially radially and in the circumferential direction,
wherein a section of the ring chamber adjoining the second flow path passage has, over more than 15% of the radial extent of the ring chamber of a seventh surface region, a reduced degree of roughness in comparison to an eighth surface region of the rest of the radial extent.
